(19) United States
(12) Patent Application Publication
(10) Pub. No.: US 2025/0391590 A1
(43) Pub. Date: Dec. 25, 2025

(54) MULTICORE CABLE ASSEMBLY MANUFACTURING METHOD, MULTICORE CABLE ASSEMBLY MANUFACTURING APPARATUS, AND STRANDING MACHINE

(71) Applicant: Proterial, Ltd., Tokyo (JP)

(72) Inventor: Ryuta TAKAHASHI, Tokyo (JP)

(21) Appl. No.: 19/236,376

(22) Filed: Jun. 12, 2025

(30) Foreign Application Priority Data
Jun. 25, 2024 (JP) 2024-102423

(51) Int. Cl. H01B 13/02; H01R 4/02

(52) U.S. Cl. CPC H01B 13/0214; H01B 13/0285; H01R 4/023

(57) ABSTRACT

A method for manufacturing a multicore cable assembly in which one ends of a plurality of spirally twisted insulated wires are connected to a plurality of electrodes of a board, includes a stripping step of removing an insulating coating at each of the one ends of the plurality of insulated wires to expose a core wire, a connecting step of connecting the core wires at the one ends of the plurality of insulated wires to the plurality of electrodes of the board after the stripping step, and a stranding step of stranding the plurality of insulated wires into a spiral shape after the connecting step.

### CROSS-REFERENCE TO RELATED APPLICATIONS

The present patent application claims the priority of Japanese patent application No. 2024-102423 filed on Jun. 25, 2024, the entire contents of which are incorporated herein by reference.

### TECHNICAL FIELD

This invention relates to a multicore cable assembly manufacturing method, a multicore cable assembly manufacturing apparatus, and a stranding machine.

### BACKGROUND OF THE INVENTION

Conventional medical devices, such as endoscopes to be inserted into the human body, have a plurality of insulated wires stranded (i.e., twisted) together in a spiral shape and a board (i.e., substrate) to which the plurality of insulated wires are connected. In manufacturing such medical devices, the twists of the spirally twisted the plurality of insulated wires are partially untwisted, an insulating coating at the tip of each insulated wire is removed to expose a core wire, and the exposed core wires are connected to electrodes on the board by soldering, for example.

In addition, in order to realize minimally invasive medical devices that reduce the burden on the subject of medical procedures such as examination and treatment, ultrafine insulated wires with core wires each having a conductor diameter of 0.1 mm or less, for example, may be used. In the manufacture of medical devices using such ultrafine insulated wires, when the plurality of insulated wires are untwisted, the stranding tendency (i.e., residual twist) of the twisted wires during the stranding causes the tips of the insulated wires to bend and twist, making it difficult to connect the insulated wires to the electrodes on the board.

To solve this problem, the applicant of the present application has proposed a multicore cable assembly as described in Patent Literature 1. In this multicore cable assembly, each of a plurality of insulated wires is plastically stretched in a longitudinal direction by an elongation ratio of 0.5% to 10.0%, thereby reducing bending tendency (i.e., residual bendiness) of the insulated wires and improving the workability of terminal treatment. The elongation rate of the insulated wires can be adjusted, for example, by increasing or decreasing the rotational resistance force of a drawing wheel in a stranding machine.

### CITATION LIST

Patent Literature 1: JP2024-025296A

### SUMMARY OF THE INVENTION

According to the multicore cable assembly described in Patent Literature 1, it is possible to reduce the bending tendency of insulated wires, but it is necessary to adjust the tension during the stranding step in a stranding machine, for example, in order to plastic stretch each of the plurality of insulated wires at a predetermined elongation rate. However, this operation is difficult in manufacturing using equipment without such an adjustment function. In addition, depending on the thickness of the insulated wire and the pitch of the multiple electrodes on the board, the difficulty of connecting the core wire of the insulated wire to the electrodes may increase even if the insulated wire has only a slight bending tendency.

It is therefore an object of the present invention to provide a multicore cable assembly manufacturing method and a multicore cable assembly manufacturing apparatus, in which the difficulty of connection work between an electrode of a board and a core wire of an insulated wire is not increased by the bending tendency of the insulated wire caused by unstranding even when an ultrafine insulated wire is used. It is also an object of the present invention to provide a stranding machine that can prevent each insulated wire from being twisted when stranding a plurality of insulated wires together, and that can be suitably used, for example, for the multicore cable assembly manufacturing method.

For the purpose of solving the above problem, one aspect of the present invention provides a method for manufacturing a multicore cable assembly in which one ends of a plurality of spirally twisted insulated wires are connected to a plurality of electrodes of a board, comprising:
a stripping step of removing an insulating coating at each of the one ends of the plurality of insulated wires to expose a core wire;
a connecting step of connecting the core wires at the one ends of the plurality of insulated wires to the plurality of electrodes of the board after the stripping step; and
a stranding step of stranding the plurality of insulated wires into a spiral shape after the connecting step.

For the purpose of solving the above problem, another aspect of the present invention provides a manufacturing apparatus for manufacturing a multicore cable assembly in which one ends of a plurality of insulated wires twisted together in a spiral shape are connected to a plurality of electrodes of a board, comprising:
a board holding section for holding the board, a rotating body in which a plurality of tubular bodies are arranged along a circumferential direction around a rotation axis;
a plurality of drawn members to be fixed to respective other ends of the plurality of insulated wires; and
a pump for suctioning each of the plurality of drawn members,
wherein the plurality of insulated wires are twisted together by rotating the rotating body while suctioning each of the plurality of drawn members with the pump, with the plurality of drawn members being placed inside the plurality of tubular bodies, respectively . . .

For the purpose of solving the above problem, a still another aspect of the present invention provides a stranding machine, comprising:
a rotating body having a plurality of tubular bodies arranged along a circumferential direction centering on a rotation axis;
a plurality of drawn members to be fixed to respective ends of the plurality of insulated wires; and
a pump for suctioning each of the plurality of drawn members,
wherein the plurality of insulated wires are twisted together in a spiral shape by rotating the rotating body while suctioning each of the plurality of drawn members with the pump, with the plurality of drawn members being placed inside the plurality of tubular bodies, respectively.

### Advantageous Effects of the Invention

According to the present invention, it is possible to provide a multicore cable assembly manufacturing method and a multicore cable assembly manufacturing apparatus, in which the difficulty of connection work between an electrode of a board and a core wire of an insulated wire is not increased by the bending tendency of the insulated wire caused by unstranding even when an ultrafine insulated wire is used. According to the present invention, it is also possible to provide a stranding machine that can prevent each insulated wire from being twisted when stranding a plurality of insulated wires together, and that can be suitably used, for example, for the multicore cable assembly manufacturing method.

### BRIEF DESCRIPTION OF THE DRAWINGS

FIG. 1A is a configuration diagram showing a configuration example of a multicore cable assembly in one embodiment of the present invention.

FIG. 1B is a cross-sectional view of the multicore cable assembly taken along line A-A in FIG. 1A.

FIG. 1C is a cross-sectional view of one insulated wire.

FIG. 2 is an explanatory diagram showing a board and the plurality of insulated wires in a connecting step.

FIG. 3 is a configuration diagram showing a schematic configuration example of a stranding machine used in a stranding step.

FIG. 4 is a configuration diagram showing a planetary gear mechanism viewed from an axial direction.

FIG. 5A is an explanatory diagram showing a mandrel housed inside a suction pipe by breaking off a portion of the suction pipe, together with an insulated wire.

FIG. 5B is a cross-sectional view of the mandrel along the axial direction.

### DETAILED DESCRIPTION OF THE INVENTION

### Embodiment

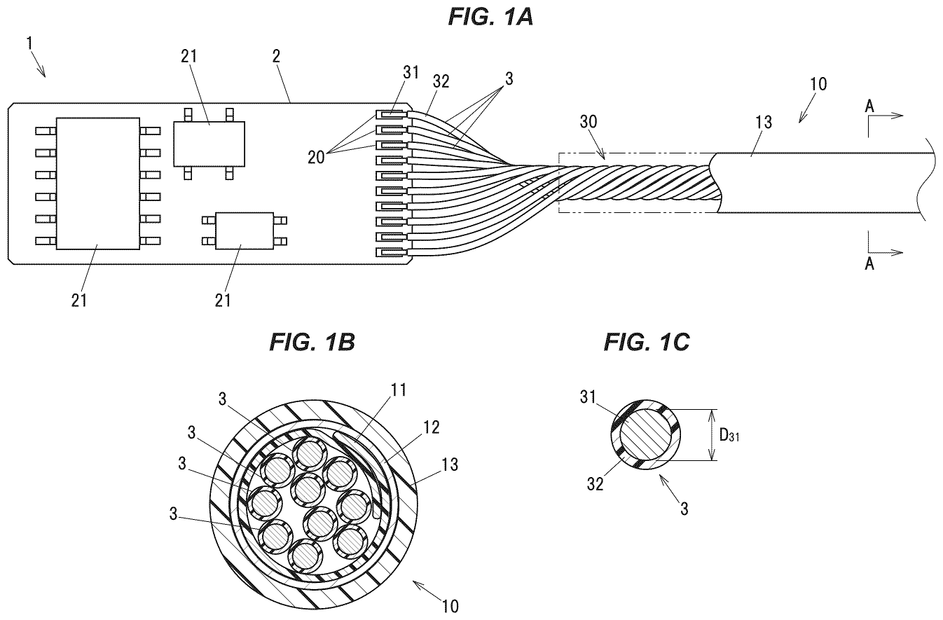

FIG. 1A is a configuration diagram showing a configuration example of a multicore cable assembly 1 in one embodiment of the present invention. FIG. 1B is a cross-sectional view of the multicore cable assembly 1 taken along line A-A in FIG. 1A. FIG. 1C is a cross-sectional view of one insulated wire 3. The multicore cable assembly 1 is used, for example, as a component of medical devices such as an endoscope that is configured to be inserted into the human body.

The multicore cable assembly 1 has a board (i.e., substrate) 2 on which a plurality of electronic components 21 are mounted, and a cable 10. The cable 10 has a plurality of insulated wires (i.e., insulated electric wires) 3. In the present embodiment, as an example, the cable 10 has a binder tape 11 wrapped around an outer circumference of the plurality of insulated wires 3, a shield conductor 12 provided around an outer circumference of the binder tape 11, and a tubular sheath 13 provided around an outer circumference of the shield conductor 12. The plurality of insulated wires 3 are stranded (i.e., twisted) together to form a cable core 30.

The sheath 13 is made of, e.g., fluoroplastic, and collectively covers the plurality of insulated wires 3 together with the binder tape 11 and the shield conductor 12. In FIG. 1A, the outline of the sheath 13 is shown in a part of the cable 10 in the longitudinal direction as a double-dashed line, indicating the appearance of the cable core 30. The flexibility of the cable 10 is enhanced by the plurality of insulated wires 3 being twisted together inside the sheath 13. Depending on the flexibility and noise resistance required for the cable 10, one or both of the binder tape 11 and the shield conductor 12 may be omitted. The cable 10 may not have the sheath 13.

In the present embodiment, the cable 10 has ten insulated wires 3. Some of the insulated wires 3 are used to supply power to the plurality of electronic components 21, while other insulated wires 3 are used to transmit signals. In the present embodiment, the thickness and material of the ten insulated wires 3 are common. However, the invention is not limited thereto. For example, the insulated wire 3 for power supply may be thicker than the insulated wire 3 for signal transmission.

The board 2 has the same number of electrodes 20 as the number of insulated wires 3. The twenty electrodes are pads formed by etching a good-conducting metal foil such as copper foil, for example, or they may be pads formed by sputtering of good-conducting metal. In the present embodiment, the board 2 is rectangular in shape, and the ten electrodes 20 are formed in a row at one end of the long side direction of the board 2. The board 2 is a flexible board with a film-like substrate made of a dielectric material such as polyimide, for example, but may also be a solid board with a rigid plate-like substrate such as glass epoxy. A wiring pattern extending from each of the plurality of electrodes 20 is formed on a front surface of the board 2, but the wiring pattern is omitted in FIG. 1A. The number and function of the electronic components 21 mounted on the board 2 vary depending on the application of the multicore cable assembly 1.

Each insulated wire 3 has a core wire 31 made of a good conductive metal, and an insulating coating 32 covering the core wire 31, as shown in FIG. 1C. The core wire 31 is a single wire (i.e., solid wire) with a circular cross-section and is made of, for example, copper or a copper alloy, or aluminum or an aluminum alloy. A conductor diameter D₃₁ of the core wire 31 is, for example, 100 μm or less, and one more specific example is 30 μm or more and 50 μm or less. The insulating coating 32 is an insulator made of a resin, such as polyurethane, polyester, polyesterimide, polyamideimide, or polyimide.

The plurality of insulated wires 3 are connected at one end in the longitudinal direction to the plurality of electrodes 20 of the board 2, respectively. At the portion where the insulated wire 3 is connected to the electrode 20 of the board 2, the insulating coating 32 is removed to expose the core wire 31. The core wire 31 is connected to the electrode 20 by soldering, for example, but the invention is not limited thereto. The core wire 31 may be connected to the electrode 20 by conductive adhesive, for example, or by welding.

If the insulated wires 3 are wavy (i.e., undulated) when connecting the core wires 31 of the plurality of insulated wires 3 to the electrodes 20 during the manufacture of the multicore cable assembly 1, the difficulty of connecting the insulated wires 3 to the electrodes 20 increases and the manufacturing cost increases due to longer working time. Undulation of the insulated wires 3 occurs, for example, when the plurality of insulated wires 3 are twisted together in a spiral shape and then untwisted. This is because the stranding tendency (i.e., residual twist) of the twisted wires remains in the insulated wires 3 when they are twisted together. The undulation caused by this stranding tendency is particularly large in ultrafine insulated wires 3, for example, where the conductor diameter D₃₁ is 100 μm or less.

In the conventional method for manufacturing multicore cable assembly, a plurality of insulated wires are twisted together to form a cable core, the cable core is cut to a predetermined length, and then the plurality of insulated wires are untwisted at the end of the cable core for connection to the electrodes of the board. In contrast, in the present embodiment, the plurality of insulated wires 3 are connected to the board 2, and then the plurality of insulated wires 3 are twisted together.

In other words, in the present embodiment, the multicore cable assembly 1 is manufactured by a manufacturing method having the following steps: a stripping step of removing the insulating coating 32 at one end of each of the plurality of insulated wires 3 to expose the core wire 31; a connecting step of connecting the core wire 31 at the one end of each of the plurality of insulated wires 3 to the electrode 20 on the board 2 after the stripping step; and a stranding step of stranding the plurality of insulated wires 3 in a spiral shape after the connecting step. This allows the connection work of the insulated wires 3 to be performed without stranding tendency (i.e., residual twist), thereby improving work efficiency.

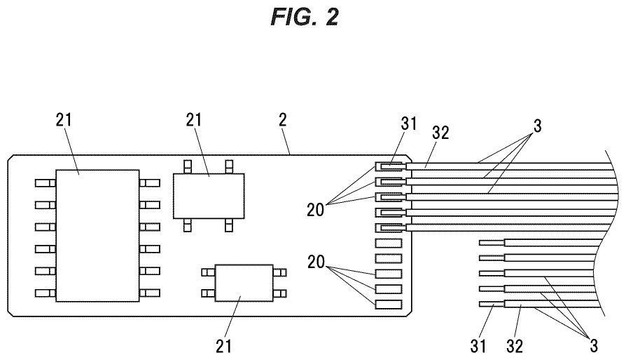

FIG. 2 is an explanatory diagram showing the board 2 and the plurality of insulated wires 3 in the connecting step. In the connecting step, the respective core wires 31 of the plurality of insulated wires 3 are connected to the plurality of electrodes 20 of the board 2 on which the plurality of electronic components 21 are mounted. In FIG. 2, the core wires 31 of five insulated wires 3 of ten insulated wires 3 are shown connected to the electrodes 20. By connecting the core wires 31 of the plurality of insulated wires 3 to the electrodes 20 of the board 2 before stranding the plurality of insulated wires 3 into a spiral shape, the connection work can be performed efficiently with the insulated wires 3 free from stranding tendency (i.e., residual twist) and in a state substantially straight. Further, in the conventional manufacturing method, in order to connect the bent and undulated insulated wires to the electrodes of the board, this connection work had to be done manually by a worker under a microscope or magnifying glass, for example. Meanwhile, in the present embodiment, the connection work can be done with the insulated wires 3 without any stranding tendency (i.e., residual twist) so that the connection work can be mechanized and performed automatically.

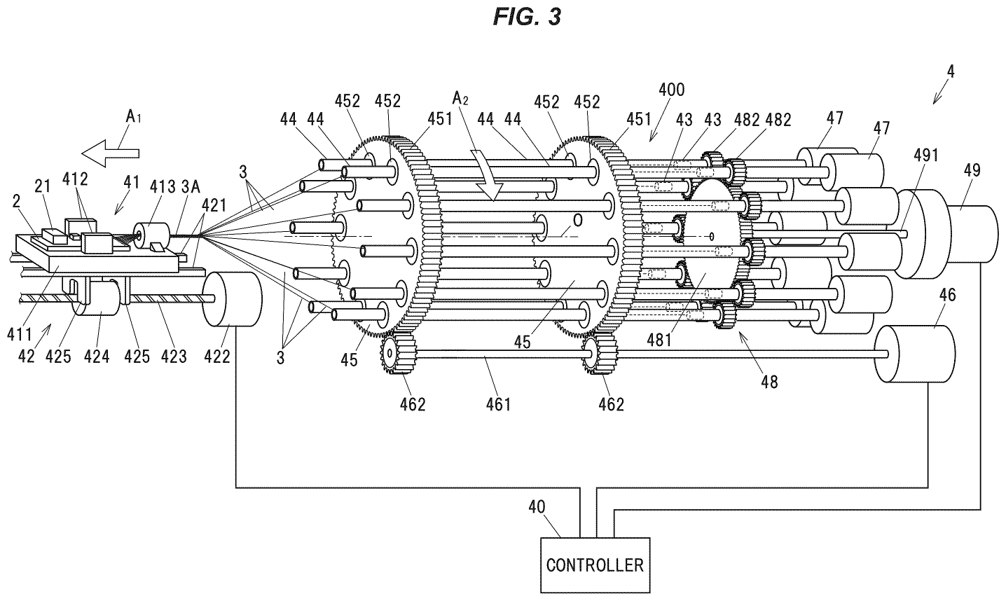

FIG. 3 is a configuration diagram showing a schematic configuration example of a stranding machine 4 used in a stranding step. The stranding machine 4 has a slide table 41 as a board holding section that holds the board 2, a moving mechanism 42 that moves the slide table 41, a plurality of mandrels 43 as drawn members (i.e., sucktioned members) fixed to the other end of each of a plurality of insulated wires 3 one end of which is connected to the board 2, a plurality of suction pipes 44 as tubular bodies that support the plurality of mandrels 43, a support plate 45 that supports the plurality of suction pipes 44, a first motor 46 rotating the support plates 45, a pump 47 sucking air out of the suction pipes 44 to suction the mandrels 43 away from the board 2, and planetary gearwheels arranged axially alongside the support plate 45, a second motor 49 that rotates a sun gear 481 of the planetary gear mechanism 48, and a controller (i.e., control unit) 40 that controls the first motor 46 and the second motor 49. In FIG. 3, the mandrel 43 positioned inside the suction pipe 44 is shown as a dashed line.

The slide table 41 holds the board 2 to which one ends of the plurality of insulated wires 3 are connected to the plurality of electrodes 20 respectively in the connecting step. The slide table 41 has a mounting base 411 on which the board 2 to which the plurality of insulated wires 3 are connected is placed, a fixing member 412 for fixing the board 2 to the mounting base 411, and a die 413 with die holes through which the plurality of insulated wires 3 are inserted. The die 413 has the function of bundling together the plurality of insulated wires 3 extending from the board 2, and is fixed to the mounting base 411 and moves with the board 2.

The moving mechanism 42 has a guide rail (e.g. a pair of rails) 421 that guides the slide table 41, a movement motor 422, a ball screw shaft 423 rotated by the movement motor 422, a ball screw nut 424 screwed to the ball screw shaft 423 via multiple balls, and a mounting member 425 that attaches the ball screw nut 424 to the slide table 41. The movement motor 422 is controlled by the controller 40 in synchronization with the first motor 46 and the second motor 49. When the ball screw shaft 423 is rotated by the movement motor 422, the slide table 41 moves along the guide rail 421. The guide rail 421 extends parallel to a rotation axis O of the rotating body 400, which will be described later. In FIG. 3, the moving direction of the slide table 41 in the stranding step is indicated by arrow A₁.

The configuration of the moving mechanism 42 is not limited to that illustrated in FIG. 3. As long as it can move the board 2 parallel to the rotation axis O, it may, for example, move the slide table 41 by a belt drive, or it may run by itself together with the slide table 41.

The stranding machine 4 has a plurality of support plates 45, and the rotational force of the first motor 46 is transmitted to the plurality of support plates 45 via a shaft 461 and a plurality of pinion gears 462. A gear portion 451 is provided on the periphery of the support plate 45, and the gear portion 451 is meshed with the pinion gear 462. Each pinion gear 462 rotates in unison with the shaft 461 to rotate the plurality of support plates 45 at a constant speed about a common rotation axis O.

The plurality of suction pipes 44 are disposed at equal intervals along the circumferential direction of the support plate 45 centered on the rotation axis O, extend parallel to the rotation axis O, and are supported by the support plate 45 via a plurality of bearings 452 held by the support plate 45. The two support plates 45, the plurality of bearings 452, and the plurality of suction pipes 44 constitute a rotating body 400 that rotates the plurality of mandrels 43 about the rotation axis O. In the stranding step, the rotation of the rotating body 400 rotates the mandrels 43, thereby stranding the plurality of insulated wires 3. In FIG. 3, the rotating direction of the rotating body 400 in the stranding step is indicated by arrow A₂.

In the example shown in FIG. 3, the stranding machine 4 has two support plates 45. The support plate 45 should be installed at appropriate intervals according to the length of the insulated wires 3 to be twisted together, and the number of support plates 45 constituting the rotating body 400 is not limited to two, but can be one, alternatively, three or more.

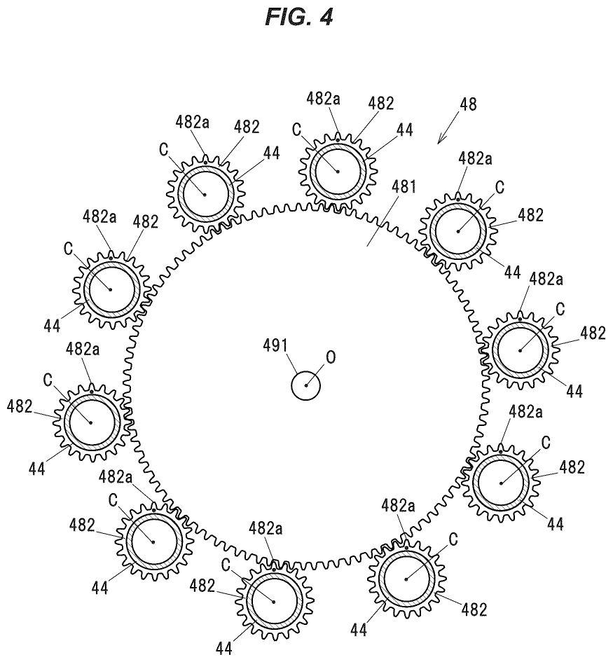

FIG. 4 is a configuration diagram showing the planetary gear mechanism 48 viewed from an axial direction. The planetary gear mechanism 48 has a sun gear 481 rotating about the rotation axis O, and a plurality of planetary gears 482 meshed with the sun gear 481. The plurality of suction pipes 44 are fixed to the plurality of planetary gears 482, respectively. Each suction pipe 44 passes through the planetary gear 482 in an axial direction parallel to the rotation axis O. At the center of the sun gear 481 is fixed a shaft 491 that transmits the rotational force of the second motor 49 to the sun gear 481.

The controller 40 controls the rotation speed of the first motor 46 and the second motor 49 so that the rotation position (i.e., spinning position) of each planetary gear 482 viewed from the axial direction does not change when each planetary gear 482 rotates around the rotation axis O with the suction pipe 44. As a result, in the stranding step, the plurality of planetary gears 482 revolve without spinning. Here, the rotation (i.e., spinning) means that each planetary gear 482 rotates around its own central axis C, and revolution (i.e., orbital rotation) means that each planetary gear 482 rotates around the rotation axis O of the sun gear 481.

In FIG. 4, the vertical direction of the drawing is up and down in the vertical direction of the stranding machine 4, and a black circle (●) is marked corresponding to a gear tooth 482a that is the most vertically upward position among the plurality of gear teeth of the planetary gears 482. As the plurality of planetary gears 482 revolve without spinning in the stranding step, each planetary gear 482 revolves around the rotation axis O while keeping the gear tooth 482a marked with a black circle at the most vertically upward position. As a result, the suction pipe 44 fixed to each planetary gear 482 does not rotate around the central axis C, and torsion of the plurality of insulated wires 3 is suppressed. Here, the torsion refers to the twist around the center that occurs in a single insulated wire 3.

In other words, the stranding step is a step of stranding the plurality of insulated wires 3 while suppressing the torsion of each of the plurality of insulated wires 3. By suppressing the torsion of the insulated wire 3, it is possible to prevent wire breakage of the insulated wire 3 caused by the torsion of the insulated wire 3 and unraveling (unstranding) of the stranding of the plurality of insulated wires 3.

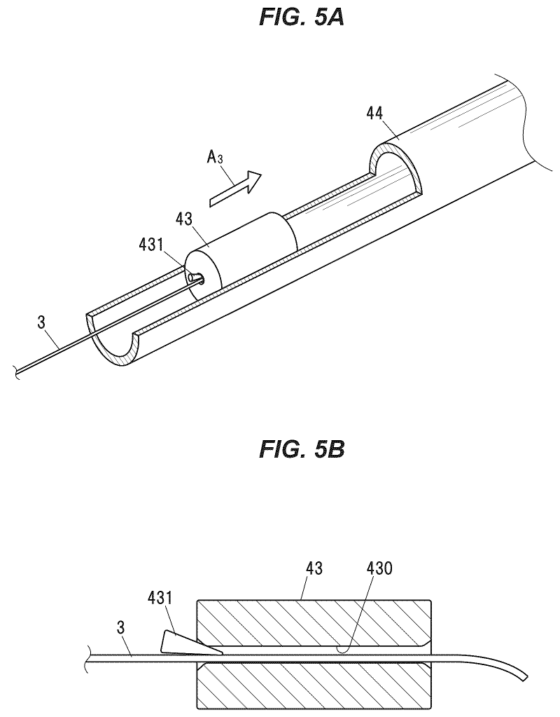

FIG. 5A is an explanatory diagram showing the mandrel 43 housed inside the suction pipe 44 by breaking off a portion of the suction pipe 44, together with the insulated wire 3. FIG. 5B is a cross-sectional view of the mandrel 43 along the axial direction. The mandrel 43 is cylindrical and has a shaft hole 430 along the axial direction in its center. The shaft hole 430 accommodates the end of the insulated wire 3 on the opposite side of the board 2, and the insulated wire 3 is held out of the shaft hole 430 by a conical retaining member 431 that is pressed into the shaft hole 430 together with the insulated wire 3. The outer diameter of the mandrel 43 is smaller than the inner diameter of the suction pipe 44. The fixing structure for fixing the insulated wire 3 to the mandrel 43 is not limited to those illustrated in FIGS. 5A and 5B, but various configurations can be used.

The mandrel 43 is axially movable within the suction pipe 44 and moves within the suction pipe 44 toward the end on the board 2-side as the stranding of the plurality of insulated wires 3 in the stranding step progresses. In the stranding step, the plurality of insulated wires 3 are twisted together by rotating the rotating body 400 while the mandrel 43 is suctioned by the pump 47 inside each of the plurality of suction pipes 44. In FIG. 5A, the suction direction of the mandrel 43 by the pump 47 is indicated by arrow A₃. The moving direction of the mandrel 43 in the suction pipe 44 in the stranding step is opposite to the suction direction of the mandrel 43 by the pump 47.

In the present embodiment, the same number of pumps 47 as the insulated wires 3 are attached to the ends of the suction pipes 44, respectively. However, the invention is not limited thereto, and a single or a smaller number of pumps than the number of suction pipes 44 may be used to suction the mandrels 43 in the multiple suction pipes 44. Each of the pumps 47 is supplied with a drive current via a slip ring with brushes, for example. The pumps 47 suction the mandrels 43 in the suction pipes 44 to provide a constant tension to the plurality of insulated wires 3 in the stranding step, regardless of the position of the mandrels 43 in the suction pipes 44.

In the stranding step, the plurality of insulated wires 3 drawn from the plurality of suction pipes 44 are twisted into a spiral shape by moving the slide table 41 away from the rotating body 400 and the sun gear 481 and the plurality of planetary gears 482 of the planetary gear mechanism 48 while rotating the rotating body 400. In FIG. 3, the twisted portion of the plurality of insulated wires 3 is indicated by the code “3A”. The portion 3A where the plurality of insulated wires 3 are twisted together is on the extension of the rotation axis O of the rotating body 400. When the insulated wire 3 is pulled out of the suction pipe 44 and the mandrel 43 reaches the end of the suction pipe 44, the stranding step is completed.

Thereafter, the binder tape 11 is wrapped around the outer circumference of the cable core 30 in which the insulated wires 3 are twisted together in a spiral shape, the shield conductor 12 is provided to cover the binder tape 11, and the sheath 13 is extruded to form the multicore cable assembly 1 shown in FIG. 1. The stranding strength (twist pitch) of the plurality of insulated wires 3 in the cable core 30 can be adjusted by the moving speed of the slide table 41. The faster the moving speed of the slide table 41, the longer the twist pitch.

In the present embodiment, the case of stranding the plurality of insulated wires 3 by moving the slide table 41 holding the board 2 with respect to the rotating body 400 is described, but the invention is not limited thereto. The position of the board 2 may be fixed and the rotating body 400 may be moved in the direction going away from the board 2 in parallel with the rotation axis O. In other words, if it is possible to move the board 2 to which the plurality of insulated wires 3 are connected and the rotating body 400 relatively along the rotation axis O, the rotation of the rotating body 400 can twist the plurality of insulated wires 3 together.

In the present embodiment, the case in which the suction pipe 44 is circular in cross-section and the mandrel 43 is cylindrical, as shown in FIG. 4, is described. However, for example, the cross-sectional shape of the suction pipe 44 and at least part of the mandrel 43 may be non-circular, so that the mandrel 43 does not rotate relative to the suction pipe 44. In other words, the mandrel 43 may be axially movable and non-rotatable relative to the suction pipe 44.

### Functions and Effects of the Embodiment

According to the above-described embodiment, it is possible to prevent the increased difficulty in connection work between the electrode 20 of the board 2 and the core wire 31 of the insulated wire 3 due to the bending tendency of the insulated wire 3. Also, according to the stranding machine 4 of this embodiment, the plurality of insulated wires 3 can be twisted together after connecting the plurality of insulated wires 3 to the board 2, and the stranding tendency (i.e., residual twist) of each insulated wire 3 can be prevented when the plurality of insulated wires 3 are twisted together.

### Summary of the Embodiment

Next, the technical concepts that can be grasped from the above-described embodiment will be described with the aid of the codes, etc. in the embodiment. However, each code in the following description does not limit the components in the scope of claims to the parts, etc. specifically shown in the embodiment.

According to the first feature, a method for manufacturing a multicore cable assembly 1 in which one ends of a plurality of spirally twisted insulated wires 3 are connected to a plurality of electrodes 20 of a board 2 includes a stripping step of removing an insulating coating 32 at each of the one ends of the plurality of insulated wires 3 to expose a core wire 31; a connecting step of connecting the core wires 31 at the one ends of the plurality of insulated wires 3 to the plurality of electrodes 20 of the board 2 after the stripping step; and a stranding step of stranding the plurality of insulated wires 3 into a spiral shape after the connecting step.

According to the second feature, in the method for manufacturing the multicore cable assembly 1 as described by the first feature, the stranding step is a step of stranding together the plurality of insulated wires 3 while suppressing the residual twist of each of the plurality of insulated wires 3.

According to the third feature, in the method for manufacturing the multicore cable assembly 1 as described by the first or second feature, the stranding step is a step of stranding the plurality of insulated wires 3 by using a rotating body 400 in which a plurality of tubular elements (suction pipes) 44 are arranged along a circumferential direction centering on a rotation axis O and rotating the rotating body 400 while suctioning each of a plurality of drawn members (mandrels) 43 fixed on the other end of each of the plurality of insulated wires 3 inside each of the plurality of tubular elements 44.

According to the fourth feature, a manufacturing apparatus (stranding machine) 4 for manufacturing a multicore cable assembly 1 in which one ends of a plurality of insulated wires 3 twisted together in a spiral shape are connected to a plurality of electrodes 20 of a board 2, includes a board holding section (slide table) 41 for holding the board 2, a rotating body 400 in which a plurality of tubular bodies 44 are arranged along a circumferential direction around a rotation axis O, a plurality of drawn members 43 to be fixed to respective other ends of the plurality of insulated wires 3, and a pump for suctioning each of the plurality of drawn members 43, wherein the plurality of insulated wires 3 are twisted together by rotating the rotating body 400 while suctioning each of the plurality of drawn members 43 with the pump 47, with the plurality of drawn members 43 being placed inside the plurality of tubular bodies 44, respectively.

According to the fifth feature, a stranding machine 4 includes a rotating body 400 having a plurality of tubular bodies 44 arranged along a circumferential direction centering on a rotation axis O, a plurality of drawn members 43 to be fixed to respective ends of the plurality of insulated wires 3, and a pump 47 for suctioning each of the plurality of drawn members 43, wherein the plurality of insulated wires 3 are twisted together in a spiral shape by rotating the rotating body 400 while suctioning each of the plurality of drawn members 43 with the pump 47, with the plurality of drawn members 43 being placed inside the plurality of tubular bodies 44, respectively.

The above description of the embodiment of the invention does not limit the invention to the scope of the claims. It should also be noted that not all of the combinations of features described in the embodiment are essential for solving the problems of the invention. The applications of the multicore cable assemblies produced by the manufacturing method or manufacturing apparatus of the present invention are not limited to medical devices, but can also be used for a variety of products.

1. A method for manufacturing a multicore cable assembly in which one ends of a plurality of spirally twisted insulated wires are connected to a plurality of electrodes of a board, comprising:
a stripping step of removing an insulating coating at each of the one ends of the plurality of insulated wires to expose a core wire;
a connecting step of connecting the core wires at the one ends of the plurality of insulated wires to the plurality of electrodes of the board after the stripping step; and
a stranding step of stranding the plurality of insulated wires into a spiral shape after the connecting step.

2. The method for manufacturing the multicore cable assembly, according to claim 1, wherein the stranding step comprises a step of stranding together the plurality of insulated wires while suppressing a residual twist of each of the plurality of insulated wires.

3. The method for manufacturing the multicore cable assembly, according to claim 1, wherein the stranding step comprises a step of stranding the plurality of insulated wires by using a rotating body in which a plurality of tubular elements are arranged along a circumferential direction centering on a rotation axis and rotating the rotating body while suctioning each of a plurality of drawn members fixed on the other end of each of the plurality of insulated wires inside each of the plurality of tubular elements.

4. A manufacturing apparatus for manufacturing a multicore cable assembly in which one ends of a plurality of insulated wires twisted together in a spiral shape are connected to a plurality of electrodes of a board, comprising:
a board holding section for holding the board, a rotating body in which a plurality of tubular bodies are arranged along a circumferential direction around a rotation axis;
a plurality of drawn members to be fixed to respective other ends of the plurality of insulated wires; and
a pump for suctioning each of the plurality of drawn members,
wherein the plurality of insulated wires are twisted together by rotating the rotating body while suctioning each of the plurality of drawn members with the pump, with the plurality of drawn members being placed inside the plurality of tubular bodies, respectively.

5. A stranding machine, comprising:
a rotating body having a plurality of tubular bodies arranged along a circumferential direction centering on a rotation axis;
a plurality of drawn members to be fixed to respective ends of the plurality of insulated wires; and
a pump for suctioning each of the plurality of drawn members,
wherein the plurality of insulated wires are twisted together in a spiral shape by rotating the rotating body while suctioning each of the plurality of drawn members with the pump, with the plurality of drawn members being placed inside the plurality of tubular bodies, respectively.
